(19) United States
(12) Patent Application Publication
(10) Pub. No.: US 2024/0246878 A1
(43) Pub. Date: Jul. 25, 2024

(54) HALOTOLERANT BACTERIAL STRAINS AS BIO-FERTILIZER WITH GROWTH-PROMOTING AND ABIOTIC STRESS ALLEVIATION BENEFITS FOR PLANTS AND APPLICATION THEREOF

(71) Applicant: YEDITEPE UNIVERSITESI, Istanbul (TR)

(72) Inventors: Fikrettin SAHIN, Istanbul (TR); Aissa BAKELLI, Ghardaia (DZ); Meriam Bouri YILDIZ, Istanbul (TR)

(73) Assignee: YEDITEPE UNIVERSITESI, Istanbul (TR)

(21) Appl. No.: 18/693,981

(22) PCT Filed: Sep. 21, 2021
(86) PCT No.: PCT/TR2021/050967

§ 371 Date: Mar. 21, 2024

(51) Int. Cl. C05F 11/08

(52) U.S. Cl. CPC C05F 11/08

(57) ABSTRACT

A bio-fertilizer and/or a bio-stimulant is provided, including at least one microbe selected from the group consisting of Pseudomonas monteilii (XE15) having NRRL Accession No. B-67997, Bacillus subtilis (XE18) having NRRL Accession No. B-67996, and Pseudomonas sp. (TR8) having NRRL Accession No. B-67998, and combinations thereof. The bio-fertilizer further includes a carrier and a beneficial supplemental microbe.

### CROSS REFERENCE TO THE RELATED APPLICATIONS

This application is the national phase entry of International Application No. PCT/TR2021/050967, filed on Sep. 21, 2021, the entire contents of which are incorporated herein by reference.

### TECHNICAL FIELD

The present invention relates to a bio-fertilizer and/or a bio-stimulant including at least one microbe selected from the group consisting of new halotolerant bacterial strains isolated from saline biotopes: Pseudomonas monteilii (XE15) having NRRL Accession No. B-67997, Bacillus subtilis (XE18) having NRRL Accession No. B-67996, and Pseudomonas sp. (TR8) having NRRL Accession No. B-67998, and combinations thereof.

### BACKGROUND

Modern agriculture using chemical fertilizers and pesticides has succeeded the increasing of agricultural production on a large scale and has greatly met the demands of a growing global population for centuries. However, excessive and unconditional use of these chemicals has resulted in several environmental, food security and human health issues (e.g. food contamination, pollution of surface and underground waters, salinization of soils, resistance of pathogens to large number of chemical agents etc.). Thus, new efficient alternatives are needed to enhance crop production in socio-economically and environmentally sustainable settings.

In this context, using some beneficial microbes was reported as promising strategy in agriculture to enhance plant's growth, health and nutrients uptake [1]; [2]. Many microorganisms were patented for their benefits toward plant growth promoting (PGP) and protection from bio-aggressors. They were identified as: Bacillus firmus in EP2925855A1; Achromobacter sp., Burkholderia sp., Curtobacterium sp., Enterobacter sp., Microbacterium sp., Pantoea sp., Pseudomonas sp., Rhodococcus sp., Xanthomonas sp. in AU2018204931A1, Trichoderma viride, Scopulariopsis brevicaulis in U.S. Pat. No. 9,249,061B2, Trichoderma harzianum in U.S. Pat. No. 9,961,904B2, Penicillium bilaiae in U.S. Ser. No. 10/450,237B2, Bradyrhizobium spp., Rhizobium spp., Azorhizobium spp., Sinorhizobium spp., Mesorhizobium spp. in US20160374349A1, Pseudomonas putida in U.S. Ser. No. 00/550,3651A. All these strains were isolated from agricultural environments, almost from rhizosphere or nodules of cultivated plants. Although these strains were able to promote the plant growth, by enhancing the nutrient uptakes essentially, none of them were tested under stress conditions of drought and salinity. Nowadays, water scarcity, drought, and salinity in drylands are being the most widespread and serious challenges facing the agriculture. Although recent estimates of global extent of salt-affected soils do not exist, FAO reported that 32 million ha of almost 1500 million ha of dryland agriculture, are salt-affected [3]. Therefore, there is still a need for effective alternatives for improving the plant growth and crop yield under drought and/or saline stresses.

It was reported that plants thriving under stress conditions, may recruit specific microbial species to tolerate harsh conditions [4]. Therefore, halophytes are potential sources of plant growth promoting (PGP) microbial candidates that enhance plant growth and help to resist abiotic stresses [5]. Nevertheless, the application of these microorganisms in agriculture still limited to compatibility problems related to niches applications (environmental conditions, soil types, plant species, etc.) [4]; [6]. Consequently, the action of the previous patented species were limited to one or few plant species, under optimal culture conditions. In this context, the present invention relates to beneficial bacteria from halophilic environments and their spontaneous plants, which showed promising results in enhancing plant growth of several agricultural species under optimal and stress culture conditions of drought and salinity as well. Unlike already existent patents, which claim limited applications of microbes either to soil/plant only or to seeds only, the bacteria described herein, can be applied to soil/plants as well as they can be used in seed coating (or both together) to enhance plant growth and or alleviate abiotic stresses.

### SUMMARY

The present invention relates to a bio-fertilizer and/or a bio-stimulant including at least one microbe selected from the group consisting of Pseudomonas monteilii (XE15) having NRRL Accession No. B-67997, Bacillus subtilis (XE18) having NRRL Accession No. B-67996, and Pseudomonas sp. (TR8) having NRRL Accession No. B-67998, and combinations thereof.

The invention further relates to a method for promoting plant growth and alleviating abiotic stresses (eg. salinity and drought) with the bacterial strains, and methods of making a bio-fertilizer and/or bio-stimulant.

Another aspect of the present invention relates to Pseudomonas monteilii (XE15) (NRRL B-67997), Bacillus subtilis (XE18) (NRRL B-67996), and Pseudomonas sp. (TR8) (NRRL B-67998) strains isolated from spontaneous plants (Juncus rigidus and Tamarix gallica L.) thriving in saline soils.

The originality of this invention relies on the fact that although the above-mentioned strains (Pseudomonas monteilii (XE15), Bacillus subtilis (XE18) and Pseudomonas sp. (TR8)) were isolated from saline biotopes and rhizosphere of spontaneous plants, they were still able to survive and colonize the rhizosphere of many agricultural plant species, in addition to their enhancement of crop growth under both optimal conditions of culture and abiotic stress of salinity and/or water shortage. To this regard, these strains can be applied to ameliorate crop yields in organic and sustainable agriculture as bio-fertilizers to cope with the lack or non-disposition of nutrients and as bio-stimulants in saline and arid soils to alleviate abiotic stresses.

Another aspect of the present invention relates to the application of these bacterial strains in sustainable agriculture as bio-fertilizers to enhance culture production, and reduce the use of chemical fertilizers, or/and as bio-stimulants to alleviate abiotic stress in arid and saline lands. Moreover, these bacterial strains could be used in seed coating or seed treatment to enhance seed germination by: ameliorating the seedling quality, increasing the germination rate, and decreasing the germination time.

Another useful attribute that can be provided by components (strains) of the bio-fertilizers is to increase nutrients availability in the soil, promote plant nutrients uptake, and improve the effectiveness of fertilizers.

The present invention also relates to a bio-fertilizer and/or bio-stimulant that is low-cost and eco-friendly alternative for chemical fertilizers.

The use of these bacterial strains as bio-fertilizer, or/and bio-stimulant, or/and in seed coating is low cost, eco-friendly and so that advantageous in sustainable agriculture and organic agriculture.

This object and other objects of this invention become apparent from the detailed discussion of the invention that follows.

### BRIEF DESCRIPTION OF THE DRAWINGS

“Halotolerant bacterial strains as bio-fertilizer with growth-promoting and abiotic stress alleviation benefits for plants and application thereof” developed to fulfill the objects of the present invention is illustrated in the accompanying figures wherein

FIGS. 1A-1B are a view of phosphate solubilizing activity detected in TR8 (FIG. 1A) and X1E15 (FIG. 1B) strains on NBRIP plates containing insoluble phosphate according to the method of Nautiyal (1999) [8].

FIGS. 2A-2D show the effect of seed inoculation on wheat seed germination in petri dishes after 10 days of incubation at 25° C.

FIG. 3 shows the effect of soil inoculation by different bacterial strains on the growth of pepper plants under saline stress: Negative Control (SDW), Positive Control (commercial product).

FIG. 4 shows the evolution of the bacterial populations in the soil and rhizosphere of pepper plants (CFU g⁻¹) under optimal growth conditions in greenhouse.

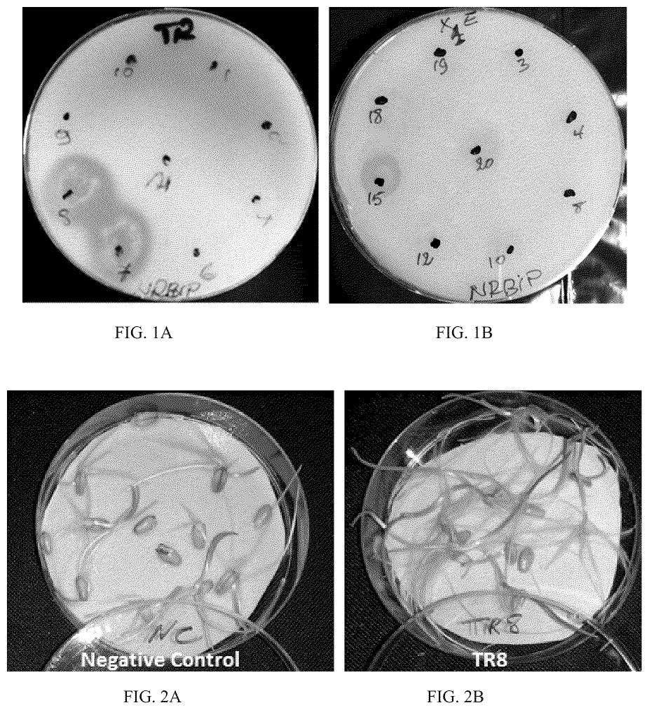

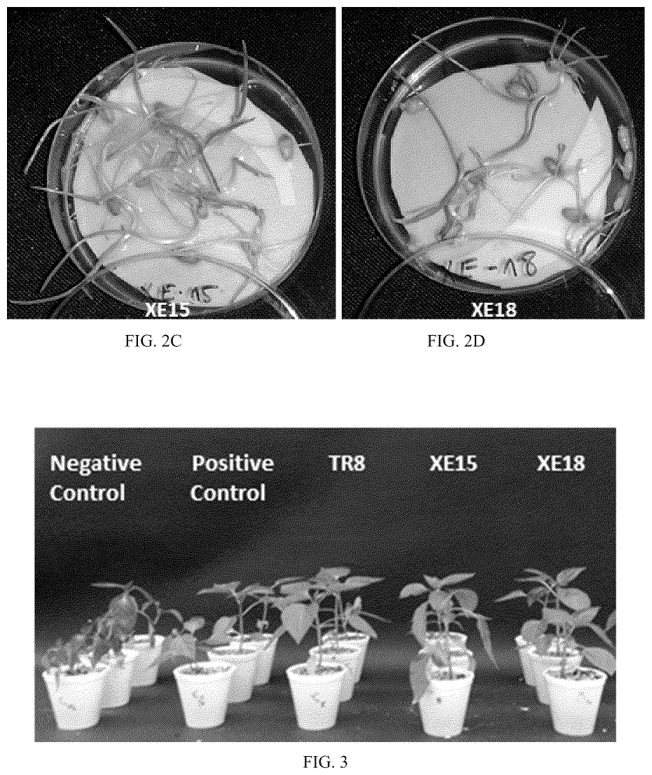

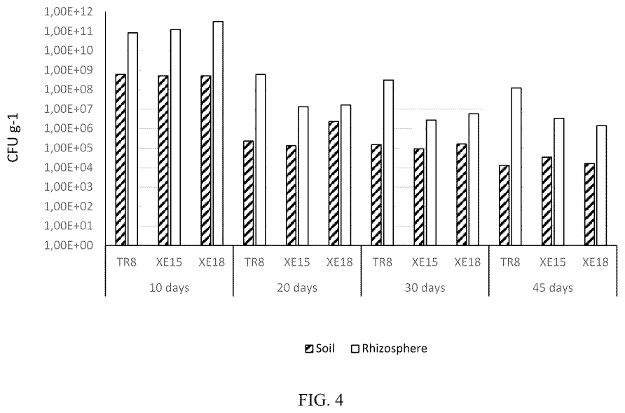

### DETAILED DESCRIPTION OF THE EMBODIMENTS

In accordance with the purpose(s) of the invention, as embodied and broadly described herein, the present invention relates to a novel bio-fertilizer and/or bio-stimulant which is isolated halotolerant strains of bacteria having beneficial attributes to plant growth and abiotic stress alleviation of drought and salinity, includes;
at least one microbe selected from the group consisting of Pseudomonas monteilii (XE15) (NRRL B-67997), Bacillus subtilis (XE18) (NRRL B-67996), and Pseudomonas sp. (TR8) (NRRL B-67998), and combinations thereof.

The term “microbe” or “microorganism” used herein refers to bacteria and archaea, fungi or protists. More preferably, the microbe defined here is at least one type of bacterial strain.

According to the present invention, the bio-fertilizer including these strains mentioned above shows plant growth-promoting attributes including atmospheric nitrogen fixation and phosphorus dissolution. Also, all isolates were able to produced indole acetic acid (IAA), siderophores, various lytic enzymes (eg. cellulose, amylase, and protease), used 1-aminocyclopropane-1-carboxylic acid (ACC) as a sole source of nitrogen.

The invention further relates to isolated halotolerant Pseudomonas monteilii (XE15) (NRRL B-67997), Bacillus subtilis (XE18) (NRRL B-67996), and Pseudomonas sp. (TR8) (NRRL B-67998) strains. These bacterial strains are isolated from the rhizospheres of spontaneous plants thriving in saline soils, which are able to promote plant growth and alleviate abiotic stresses of salinity and drought. These three strains described above deposited with Agricultural Research Service Culture Collection under NRRL numbers on 18 Nov. 2020.

The strains of the present invention may be formulated in granule, pellet, dust, powder, slurry, film, solution or liquid suspension form for fertilization uses. In one embodiment, the fertilizer is in the form of a liquid suspension. These bacterial strains could be used as biofertilizer and/or biostimulant simply suspended in a physiological solution or included into agricultural or inert carrier. The bio-fertilizer may include a carrier selected from the group consisting of water, aqueous solutions, slurries, bio-polymers, nutritive organic or mineral nutrients, and powders. According to the present invention further includes at least one additive.

In another embodiment, the bio-fertilizer/the bio-stimulant or the seed coating solution includes between 10⁹ colony forming units (“CFU”)/mL to 10¹² CFU/mL (10¹² CFU/mL is efficient according to experiments) of the at least one microbe. Higher inoculum densities didn't exhibit any phytotoxic effect.F

These microbes, herein bacterial strains, were able to maintain functional population densities in the rhizosphere around 10⁶ to 10⁸ CFU/g by the end of the experiment (after 45 days).

Any of a number of beneficial supplemental microbes can be added to the fertilizer of the present invention.

The invention further relates to a method for promoting plant growth and alleviating abiotic stresses (eg. salinity and drought) with the bio-fertilizer/bio-stimulants and/or seed coating, and methods of making thereof.

The methods of the present aspect are carried out in accordance with the previous aspect.

The present invention relates to a method of promoting plant growth and alleviating abiotic stresses of plants, the method includes:
providing a bio-fertilizer and/or bio-stimulant including.
   at least one microbe selected from the group consisting of Pseudomonas monteilii (XE15) (NRRL B-67997), Bacillus subtilis (XE18) (NRRL B-67996), and Pseudomonas sp. (TR8) (NRRL B-67998), and combinations thereof and,
contacting the fertilizer with soil, plants or plant seeds under conditions effective to promote the growth of the plants or plant seeds.

The bio-fertilizer and/or biostimulant of the present invention is applied in the same manner as conventional fertilizers. In one embodiment, a mixture of microbes of the present invention is applied directly to soil, plants, seeds or combinations of at least two of them.

Moreover, these strains showed salt tolerance (up to 18% of NaCl, in culture media and osmotolerance (up to 300% of polyethylene glycol PEG6000, in culture media)), and so that they can be used in agriculture systems under salinity and/or drought stress conditions.

These bacterial strains enhanced the germination quality of various seeds (e.g. barely, tomato, wheat, soybean, pepper, eggplant, and maize) with averages of 144.7% and 205% under optimal conditions and salinity stress, respectively.

These bacterial strains allow early germination of a few days (3-5 days) compared to the negative control set (non-treated seeds).

The soil inoculation, under optimal greenhouse conditions, with bacterial culture of XE15, XE18, TR8, and their mixture enhanced the vegetative growth of plants, compared to cultures in non-inoculated soils. Soil treatment with bacterial cultures increased shoots length (at least by 192%), roots length (at least by 130%), total fresh biomass (at least by 377⁰/), and total dry biomass (at least by 279%).

Plant growth enhancement effect of these bacterial strains and their mixture was also observed in cultures under salt stress conditions. Treated plants showed increases in shoots length (with at least 289%), roots length (with at least 158%), total fresh biomass (with at least 243%) and total dry biomass (with at least 206%).

These bacterial strains could be applied individually or mixed together without any incompatibility risk. Furthermore, these bacterial strains didn't exhibit any antagonistic activity with several beneficial microbial species (eg. Azotobacter, Bacillus, Pseudomonas, Rhizobium, Trichoderma, making them compatible with the indigenous beneficial members of the plant microbiome.

Moreover, these bacterial strains could be used alone for seed coating or incorporated with other exogenous materials used in seed coating technology.

These examples are intended to representative of specific embodiments of the invention and are not intended as limiting the scope of the invention.

### SPECIFIC EMBODIMENTS

Experimental studies lead to determine the advantages of the present invention.

### EXAMPLES

### Example 1 Bacterial Isolation

The bacterial strains were isolated on Tryptic Soy Agar medium (TSA) from different halophilic soils and rhizospheres of different spontaneous halophytes.

### Example 2 Screening of Biochemical Growth Promoting Attributes

The nitrogen fixation activity tested on NFb medium [7]. The phosphate solubilization ability was assessed according to the method of Nautiyal [8]. Quantitative estimation of inorganic phosphate solubilization was performed as described by Pikovskaya [9]. Potassium solubilization capacity was screened by the method of Aleksandrov et al. [10]. Siderophore production was checked according to Schwyn and Neilands [11]. ACC deaminase activity was identified according to the method of Glick et al [12]. The production of IAA was assessed according to Patten and Glick [13].

TABLE 1
Plant growth promotion (PGP) traits detected in the bacterial strains

| | | Phosphate solubilization | | | | Ammonia | | |
|---|---|---|---|---|---|---|---|---|
| | Nitrogen | (μg/mL) | | Potassium | Siderophore | production | | AIA |
| Isolates | fixation | Pikovskaya | NRBIP | solubilization | production | (μg/mL) | ACC | (μg/mL) |
| TR8 | + | 18 | 30 | + | + | − | + | 101.7 |
| X1E15 | + | 12 | 14 | + | + | + | + | 56.27 |
| X1E18 | − | 0.0 | 0.0 | − | + | + | + | 43.5 |

### Example 3 Bacterial Species Identification

Taxonomic investigation was performed by Bruker Microflex MALDI TOF spectrometer equipped with a UV laser at a wavelength of 337 nm, a flexControl and MBT Copass software (Bruker Daltonics, Bremen, Germany), according to the manufacturer's instructions. Scores obtained for the strains were as the following: 2.12 as Pseudomonas sp. for the strain TR8, 2.09 as Pseudomonas monteilii for the strain XE15, and 2.17 as Bacillus subtilis for the strain XE18.

TABLE 2
Results for the identification of isolated
bacteria analyzed by MALDI Biotyper.

| ISOLATES | MALDI-TOF | Score | Phylum |
|---|---|---|---|
| TR8 | Pseudomonas sp. | 2.12 | Gammaproteobacteria |
| X1E15 | Pseudomonas monteilii | 2.09 | Gammaproteobacteria |
| X1E18 | Bacillus subtilis | 2.17 | Firmicutes |

### Example 4 Enzymatic Activities

Amylolytic activity was detected by the method of Mukhtar et al. [14]. Protease production was detected on Skim Milk Agar medium as described by Loper and Schroth [15]. Cellulase production was screened by the method of Berg and Pettersson [16]. Ammonia production was checked by the method of Cappuccino and Sherman [17]. Phytase activity was tested on PSM medium as described by Howson and Davis [18].

TABLE 3
Enzymatic activities detected in the bacterial strains

| Isolates | Cellulase | Amylase | Protease |
|---|---|---|---|
| TR8 | − | − | − |
| X1E15 | − | + | + |
| X1E18 | − | + | + |

### Example 5 Antagonistic Activity

The compatibility of the described strains towards each other and other beneficial microbes were assessed according to the modified double layer method as described by Rhouma et al. (2008) [19]. No inhibition zones were detected in the bacterial cultures which reveal the absence of any antagonistic activity between the strains and so that their compatibility.

### Example 6 Salt and Drought Tolerance Capacity

Salt and drought tolerance capacity: The growth of strains was monitored in Tryptic Soy medium containing different concentrations of NaCl (0%, 3%, 6%, 12%, 15% and 18%) and polyethylene glycol (6000) (8, 10, 12.5, 15.0, 17, 20, 25.0 and 30%) to assess the salt and drought tolerance (Cardoso et al. 1201), respectively. Incubation was performed at 30° C., under agitation (100 rpm/min).

TABLE 4
Growth capacity of the bacterial strains under different
salt concentrations in Tryptic Soy medium.

| | Salt stress tolerance (NaCl) | | | | | | |
|---|---|---|---|---|---|---|---|
| | 0% | 3% | 6% | 9% | 12% | 15% | 18% |
| TR8 | + | + | + | + | + | + | + |
| XIE15 | + | + | + | + | + | + | + |
| XIE18 | + | + | + | + | + | + | + |

### Example 7 In Vitro Germination Assay Under Optimal and Stress Conditions

Germination quality of treated and non-treated seeds with bacteria was assessed according to the ISTA rules for seed testing (ISTA, 2018 [21]). Briefly, surface sterilized-seeds were soaked into Tryptic Soy Broth 10% (TSB) bacterial suspensions (10⁹ CFU/mL) for 15-20 min, before to be transferred on Petri dishes with sterile Whatman filter papers (immersed with 3 mL of Sterile Distilled Water SDW). The bacterial inoculum density attached to the seeds were estimated by plate count method on TSA.

Sterile TSB (10%) was used as negative control. For saline stress, three mL of NaCl (150 mM), were used for the immersion of Whatman filter papers instead of SDW. For drought stress, three mL of PEG6000 (10%), were used for the immersion of Whatman filter papers instead of SDW. Incubation was carried out in dark at 25° C. for 10 to 14 days. Germination rate, length of rootlets and shoots were assessed under different treatments.

TABLE 5
Effect of seed inoculation on plant growth promotion of barley under normal (0 mM
of NaCl) and saline conditions (150 mM of NaCl) in petri dishes after 14 days.

| | 0 mM | | | | 150 mM | | | |
|---|---|---|---|---|---|---|---|---|
| | | Root | Stem | Fresh | | Root | Stem | Fresh |
| | Germination | length | length | weight | Germination | length | length | weight |
| Strains | % | (cm) | (cm) | (g) | % | (cm) | (cm) | (g) |
| Control | 90% | 8.9 ± 1.5 | 8.9 ± 1.6 | 0.461 ± 0.03 | 40% | 1.6 ± 0.2 | 0.5 ± 0.1 | 0.11 ± 0.01 |
| TR8 | 95% | 11.9 ± 2.2 | 11.9 ± 2.3 | 0.59 ± 0.07 | 40% | 1.9 ± 0.5 | 0.8 ± 0.3 | 0.15 ± 0.01 |
| XIE15 | 90% | 14.2 ± 1.5 | 12.2 ± 1.6 | 0.69 ± 0.07 | 90% | 2.7 ± 1.3 | 2.1 ± 0.8 | 0.29 ± 0.01 |
| X1E18 | 98% | 14.1 ± 1.5 | 13.1 ± 1.6 | 0.72 ± 0.05 | 95% | 3.1 ± 0.5 | 2.4 ± 0.2 | 0.24 ± 0.02 |

### Example 8 Greenhouse Assay Under Optimal and Salt Stress Conditions

### 8.1—Optimal Growth Conditions

Greenhouse assays were performed on ten-days-old pepper seedlings in plastic horticultural pots containing 1500 g of sterile clay-perlite-peat soil (1:1:1) (w/w) (pH 6.5-7.2). Bacterial inoculum was prepared from overnight bacterial cultures in TSB (10%) at 30° C. and 100 rpm/min. The final bacterial densities in pots were between 10⁹ and 101° C. FU/g of soil. Fifteen post were used for each treatment with 5 replicates. The plants were irrigated equally two to three times per week by 50 to 100 mL of distilled water per pot. No nutritive supplements were added to pots during the greenhouse experiment. Greenhouse growing conditions were as the following: light cycle of 14 h light and 10 h dark phase, with a mean light phase temperature of 30° C. and dark phase temperature of 24° C.

After 45 days, the plants were harvested, roots and shoots length, fresh and dry weight were recorded. For the dry weight, plant materials were incubated at 80° C. until a constant weight was observed. The chlorophyll content was also measured by the CCM series of Leaf Chlorophyll Content Meters.

TABLE 6
Effect of soil inoculation by the bacterial strains on plant growth of
pepper, after 45 days of culture under optimal greenhouse conditions.

| | Negative | | | | |
|---|---|---|---|---|---|
| | Control | TR8 | X1E15 | X1E18 | Mix(*) |
| Percentage of | 40 | 65 | 90 | 90 | 90 |
| Germination (%) | | | | | |
| Shoot length (cm) | 13 ± 5.4 | 25 ± 4.5 | 40 ± 5.0 | 42 ± 4.8 | 42 ± 5.2 |
| Root length (cm) | 10 ± 2.5 | 21 ± 2.9 | 13 ± 1.8 | 14 ± 1.8 | 15 ± 1.6 |
| Chlorophyll | 38.5 ± 3.45 | 42.6 ± 2.1 | 39.9 ± 2.2 | 39 ± 1.8 | 38.4 ± 2.3 |
| measurement | | | | | |
| Fresh weight (g) | 15.91 ± 2.8 | 44.03± | 73.99 ± 5.0 | 71.85 ± 2.6 | 74.58 ± 3.3 |
| Dry weight (g) | 1.83 ± 0.3 | 5.1 ± 1.2 | 7.3 ± 0.5 | 7.1 ± 0.7 | 7.3 ± 0.5 |

(*)Mix is the mixture of the three bacterial cultures (TR8, XE15, and XE18)

### 8.2—Salinity Conditions

To induce salt stress, plants were irrigated by 5 mL of sterile saline water (150 mM NaCl) every 3 days during 45 days. The monitoring of pepper growth under bacterial treatments was performed as described above in the part (7.1—Optimal growth conditions).

### 8.3—Population Survey

The inoculum density in treated soils and plants rhizosphere were estimated by plate count method on TSA, every 10 days as the following: 1 g of bulk soil was thoroughly mixed, added to 1 mL of distilled water and shaken at 300 rpm for 30 min at room temperature. Roots were cut, weighed and then soaked in SDW for 10 min with 300 rpm of agitation, to determine the rhizospheric population. Tenfold serial dilutions were suspended in SDW from the main suspensions obtained from rhizosphere and bulk soil. One hundred microliters from the 10⁵ to 10⁹ dilutions were plated into TSA and incubated at 30° C. for 48 hours for colony counting.

### REFERENCES

[1]. Souza, Rocheli de et al.: “Plant growth-promoting bacteria as inoculants in agricultural soils”; Genetics and molecular biology vol. 38,4: 401-19; doi:10.1590/51415-475738420150053; (2015).
[2]. Glick, B. R.: “Plant Growth-Promoting Bacteria: Mechanisms and Applications”; Scientifica, 2012, 1-15; doi: 10.6064/2012/963401; (2012).
[3]. FAO: “Extent and causes of salt-affected soils in participating countries. Global network on integrated soil management for sustainable use of salt-affected soils”; FAO-AGL website; (2000).
[4]. Riva V., Terzaghi E., Vergani L., Mapelli F., Zanardini E., Morosini C., Raspa G., Guardo A., Borin S.: “Exploitation of Rhizosphere Microbiome Services”; In: Reinhardt D., Sharma A. (eds) Methods in Rhizosphere Biology Research. Rhizosphere Biology. Springer, Singapore (2019).
[5]. Etesami H, Glick BR: “Halotolerant plant growth-promoting bacteria: Prospects for alleviating salinity stress in plants”; Environmental and Experimental Botany, doi: https://doi.org/10.1016/j.envexpbot.2020.104124; (2020).
[6]. Etesami H and Beattie GA.: “Mining Halophytes for Plant Growth-Promoting Halotolerant Bacteria to Enhance the Salinity Tolerance of Non-halophytic Crops”; Front. Microbiol. 9:148; (2018).
[7]. Dobereiner, J. “Forage grasses and grain crops”; In Methods for Evaluating Biological Nitrogen Fixation ed. F. J. Bergersen pp. 535-555; Chichester, UK: John Wiley & Sons; (1980).
[8]. Nautiyal, C.: “An efficient microbiological growth medium for screening phosphate solubilizing microorganisms”; FEMS Microbiology Letters, 170(1), 265-270; (1999).
[9]. Pikovskaya, RI.: “Mobilization of phosphorus in soil in connection with the vital activity of some microbial species”; Mikrobiol; 17:362-370; (1948).
[10]. Aleksandrov, V. G., Blagodyr, R. N. and Ilev, I. P.: “Liberation of phosphoric acid from apatite by silicate bacteria”; Mikrobiolohichnyi Zhurnal (Kiev) 29, 111-114; (1967).
[11]. Schwyn, B. and Neilands, J. B.: “Universal chemical-assay for the detection and determination of siderophore”; Anal Biochem; 160:47-56. pmid:2952030; (1987).
[12]. Glick, B. R.: “The enhancement of plant growth by free-living bacteria”; Canadian Journal of Microbiology, 41(2), 109-117. https://doi.org/10.1139/m95-015; (1995).
[13]. Patten, C. L., and Glick, B. R.: “Role of Pseudomonas putida indoleacetic acid in development of the host plant root system”; Applied and Environmental Microbiology, 68(8), 3795-3801; https://doi.org/10.1128/aem.68.8.3795-3801.2002; (2002).
[14]. Mukhtar, S.; Mehnaz, S.; Mirza, M S.; Malik, K. A.: “Isolation and characterization of bacteria associated with the rhizosphere of halophytes (Salsola stocksii and Atriplex amnicola) for production of hydrolytic enzymes”; Brazilian J. Microbiol., 50, 85-97; (2019).
[15]. Loper, J. E., and Schroth, M. N.: “Influence of bacterial sources of indole-3-acetic acid on root elongation of sugar beet”; Phytopathology 76:386-389; (1986)
[16]. Berg, B. and Pettersson, G.: “Location and formation of cellulases in Trichoderma viride”; Journal of Applied Bacteriology 42, 65-75; (1977).
[17]. Cappuccino, J. G, Sherman, N.: “Biochemical activities of microorganisms”; In: Microbiology, A Laboratory Manual. The Benjamin/Cummings Publishing Co. California, USA; (1992).
[18]. Howson S J, Davis R P.: “Production of phytate hydrolysing enzymes by some fungi”; Enzyme Microb. Technol., 5: 377-389; (1983).
[19]. A. Rhouma, M. Bouri, A. Boubaker and X. Nesme: “Potential effect of rhizobacteria in the management of crown gall disease caused by Agrobacterium tumefaciens”; Journal of plant pathology 90 (3), 517-526; (2008).
[20]. Cardoso P., Alves A., Silveira P., Si C., Fidalgo C., Freitas R., Figueira E.: “Bacteria from nodules of wild legume species: Phylogenetic diversity, plant growth promotion abilities and osmotolerance”, Science of The Total Environment, Volume 645, 2018, Pages 1094-1102, ISSN 0048-9697, https://doi.org/10.1016/j.scitotenv.2018.06.399; (2018).
[21]. ISTA: “International Rules for Seed testing.” Seed Science and Technology. Zurich, Switzerland; (2018).

What is claimed is:

1. A bio-fertilizer comprising:
at least one microbe selected from the group consisting of Pseudomonas monteilii (XE15) (NRRL B-67997), Bacillus subtilis (XE18) (NRRL B-67996), and Pseudomonas sp. (TR8) (NRRL B-67998).

2. The bio-fertilizer according to claim 1, wherein the bio-fertilizer is in a form of granule, pellet, dust, powder, slurry, film, and/or liquid suspension.

3. The bio-fertilizer according to claim 1, wherein the bio-fertilizer further comprises a carrier selected from the group consisting of water, aqueous solutions, slurries, bio-polymers, nutritive organics, mineral nutrients, and powders.

4. The bio-fertilizer according to claim 1, wherein the bio-fertilizer further comprises a beneficial supplemental microbe.

5. A method of promoting a growth of plants and alleviating abiotic stresses of the plants, the method comprising:
providing a bio-fertilizer comprising:
at least one microbe selected from the group consisting of Pseudomonas monteilii (XE15) (NRRL B-67997), Bacillus subtilis (XE18) (NRRL B-67996), and Pseudomonas sp. (TR8) (NRRL B-67998), and combinations thereof; and
contacting the bio-fertilizer with soil, the plants, or plant seeds under conditions effective to promote the growth of the plants or a growth of the plant seeds.
